(19) United States
(12) Patent Application Publication
(10) Pub. No.: US 2014/0094202 A1
(43) Pub. Date: Apr. 3, 2014

(54) MISSED CALL ALARMING METHOD AND COMMUNICATION DEVICE WITH MISSED CALL ALARMING FUNCTION

(71) Applicant: WISTRON CORPORATION, New Taipei City (TW)

(72) Inventor: Rose Xu, New Taipei City (TW)

(73) Assignee: WISTRON CORPORATION, New Taipei City (TW)

(21) Appl. No.: 13/693,059

(22) Filed: Dec. 4, 2012

(30) Foreign Application Priority Data
Sep. 29, 2012 (CN) 201210375322.5

(51) Int. Cl. H04M 3/02

(52) U.S. Cl. CPC H04M 3/02
USPC 455/458

(57) ABSTRACT

A missed call alarming method includes steps of accumulating a number of missed calls; determining whether the number of missed calls is larger than a missed call threshold; and adjusting a ring volume to maximum level and sending an alarm ring out by the ring volume when the number of missed calls is larger than the missed call threshold.

### BACKGROUND OF THE INVENTION

1. Field of the Invention

The invention relates to a communication device and, more particularly, to a communication device with missed call alarming function and a missed call alarming method.

2. Description of the Prior Art

So far communication device (e.g. mobile phone) is considered a necessity by a lot of people. In general, a user may selectively set ring volume of the communication device to silent mode, vibration mode, ring mode and so on for different conditions. Also, the ring volume may be set to different levels under the ring mode. When a user attends a meeting or is not allowed to generate noise at a place, such as movie theater, music performance and so on, he or she usually sets the communication device to silent mode or vibration mode. If the user does not notice that there is an incoming call, the user forgets to set the communication device back to ring mode after the event, or the ring volume is too small, he or she will miss some urgent calls accordingly.

### SUMMARY OF THE INVENTION

The invention provides a communication device with missed call alarming function and a missed call alarming method so as to solve the aforesaid problems.

According to the claimed invention, a missed call alarming method comprises steps of accumulating a number of missed calls; determining whether the number of missed calls is larger than a missed call threshold; and adjusting a ring volume to maximum level and sending an alarm ring out by the ring volume when the number of missed calls is larger than the missed call threshold.

According to the claimed invention, the missed call alarming method further comprises steps of recording the number of missed calls in a missed call list; and displaying a process status of the missed call in the missed call list.

According to the claimed invention, the missed call alarming method further comprises step of setting the missed call threshold in an alarm setting interface.

According to the claimed invention, the missed call alarming method further comprises step of setting a sound file, a voice file or a music file to be the alarm ring in the alarm setting interface.

According to the claimed invention, the missed call alarming method further comprises steps of setting a pause interval in the alarm setting interface; and sending the alarm ring out discontinuously according to the pause interval.

According to the claimed invention, the missed call alarming method further comprises steps of setting a continuous interval in the alarm setting interface; and sending the alarm ring out continuously within the continuous interval.

According to the claimed invention, a communication device with missed call alarming function comprises a counter for accumulating a number of missed calls; a speaker; and a processor, electrically connected to the counter and the speaker, for determining whether the number of missed calls is larger than a missed call threshold, the processor adjusting a ring volume to maximum level and driving the speaker to send an alarm ring out by the ring volume when the number of missed calls is larger than the missed call threshold.

According to the claimed invention, the communication device with missed call alarming function further comprises a storage unit, electrically connected to the processor, for storing a missed call list, wherein the processor records the number of missed calls in the missed call list and displays a process status of the missed call in the missed call list.

According to the claimed invention, the communication device with missed call alarming function further comprises a display unit, electrically connected to the processor, for displaying an alarm setting interface; and a touch unit, electrically connected to the processor, for setting the missed call threshold in the alarm setting interface.

According to the claimed invention, the touch unit is used for setting a sound file, a voice file or a music file to be the alarm ring in the alarm setting interface.

According to the claimed invention, the touch unit is used for setting a pause interval in the alarm setting interface and the processor drives the speaker to send the alarm ring out discontinuously according to the pause interval.

According to the claimed invention, the touch unit is used for setting a continuous interval in the alarm setting interface and the processor drives the speaker to send the alarm ring out continuously within the continuous interval.

As mentioned in the above, when the communication device has a missed call, the counter will accumulate the number of missed calls and the processor will determine whether the number of missed calls is larger than the missed call threshold (e.g. three, five, etc.). When the number of missed calls is larger than the missed call threshold, the processor will adjust the ring volume to maximum level and drive the speaker to send the alarm ring out by the ring volume in maximum level so as to make the user notice that there is a missed call. Accordingly, the invention can prevent the user from missing urgent calls due to silent mode, vibration mode or small ring volume. Furthermore, the user can set exclusive alarm ring for different contacts and set pause interval and continuous interval of sending the alarm ring out.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram illustrating a communication device with missed call alarming function according to an embodiment of the invention.

FIG. 2 is a schematic diagram illustrating a first screen displayed by the communication device shown in FIG. 1.

FIG. 3 is a schematic diagram illustrating a second screen displayed by the communication device shown in FIG. 1.

FIG. 4 is a schematic diagram illustrating a third screen displayed by the communication device shown in FIG. 1.

FIG. 5 is a schematic diagram illustrating a fourth screen displayed by the communication device shown in FIG. 1.

FIG. 6 is a schematic diagram illustrating a fifth screen displayed by the communication device shown in FIG. 1.

FIG. 7 is a schematic diagram illustrating a sixth screen displayed by the communication device shown in FIG. 1.

FIG. 8 is a flowchart illustrating a missed call alarming method according to an embodiment of the invention.

### DETAILED DESCRIPTION

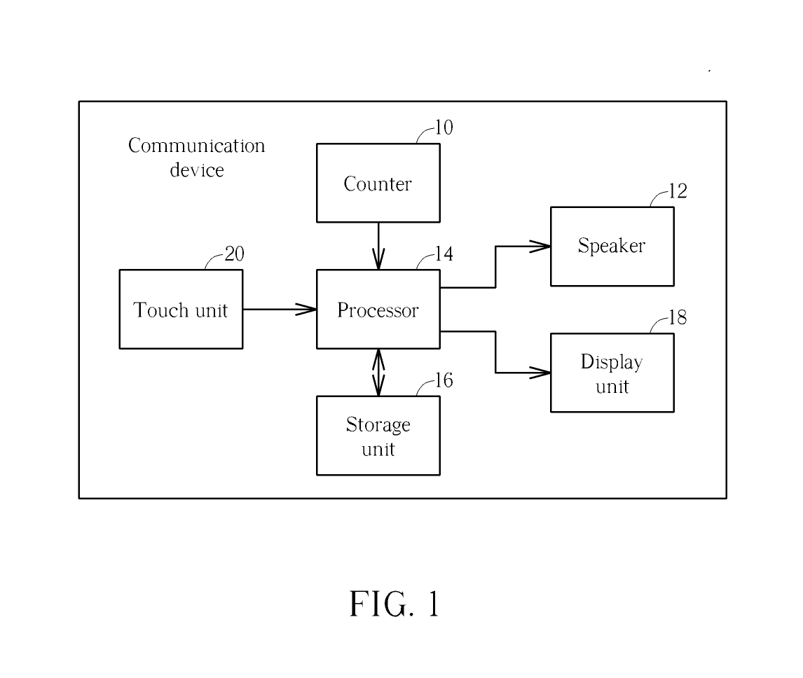

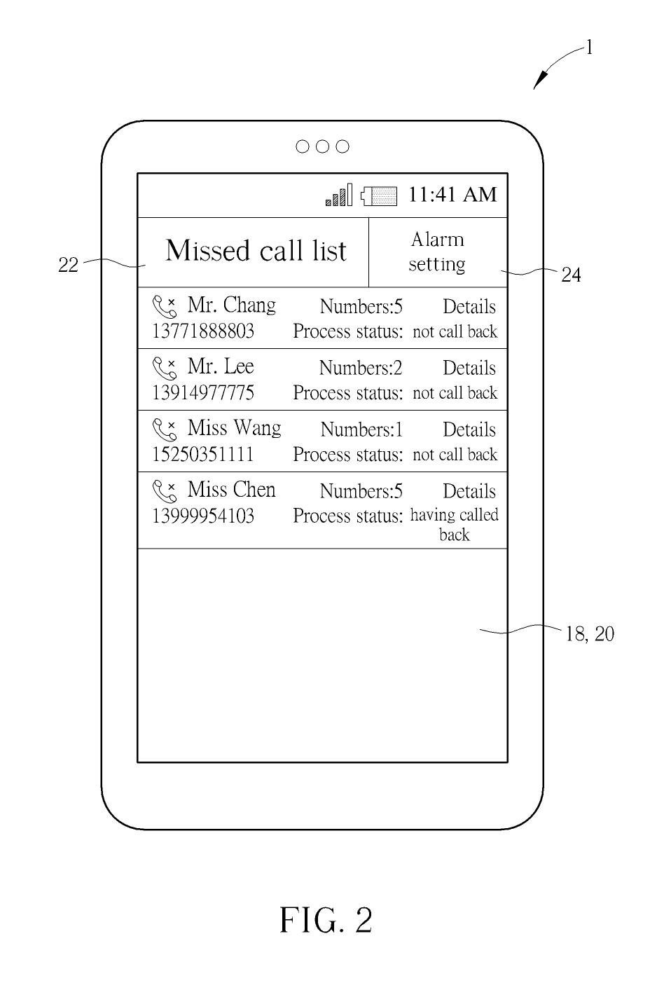

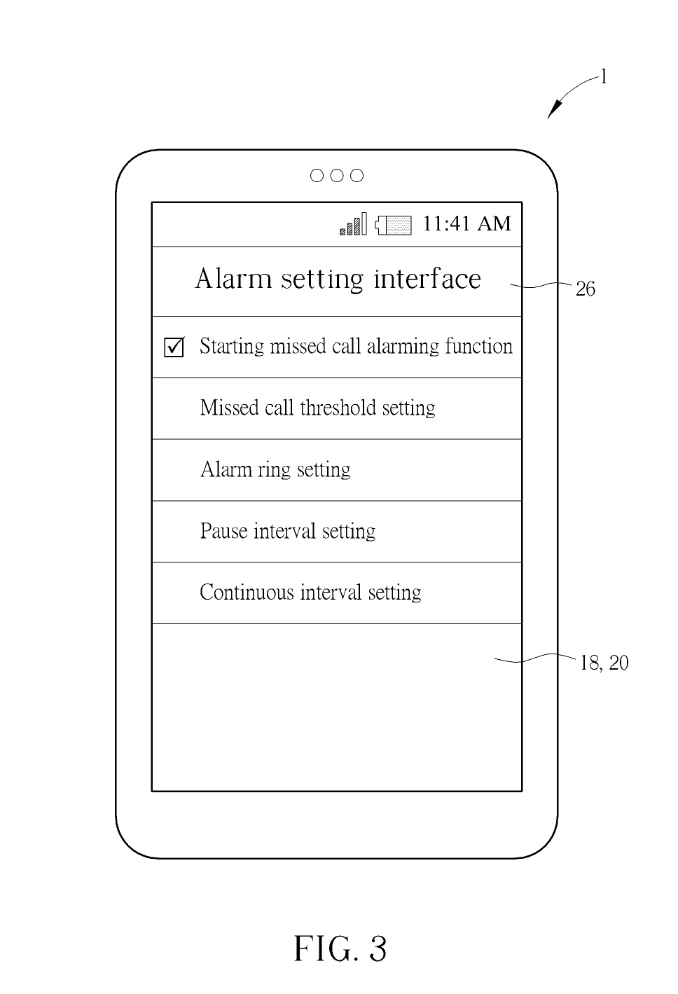

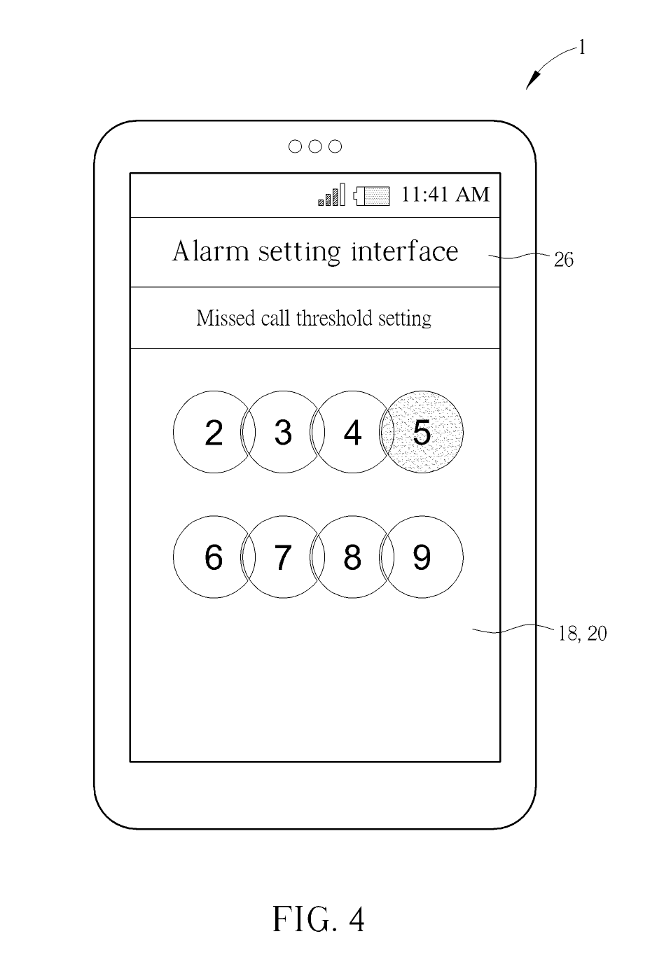

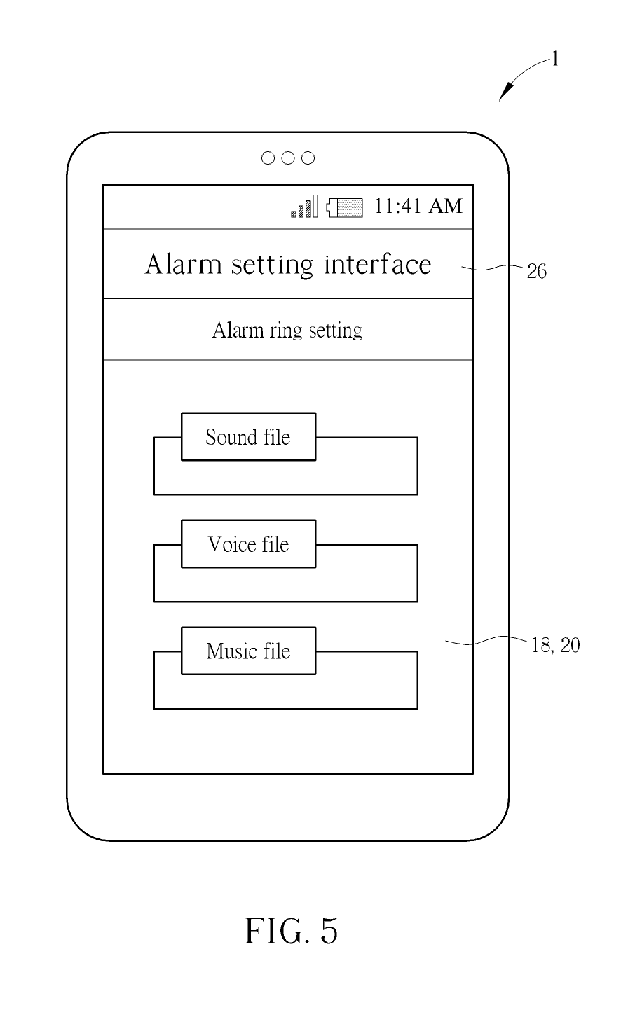

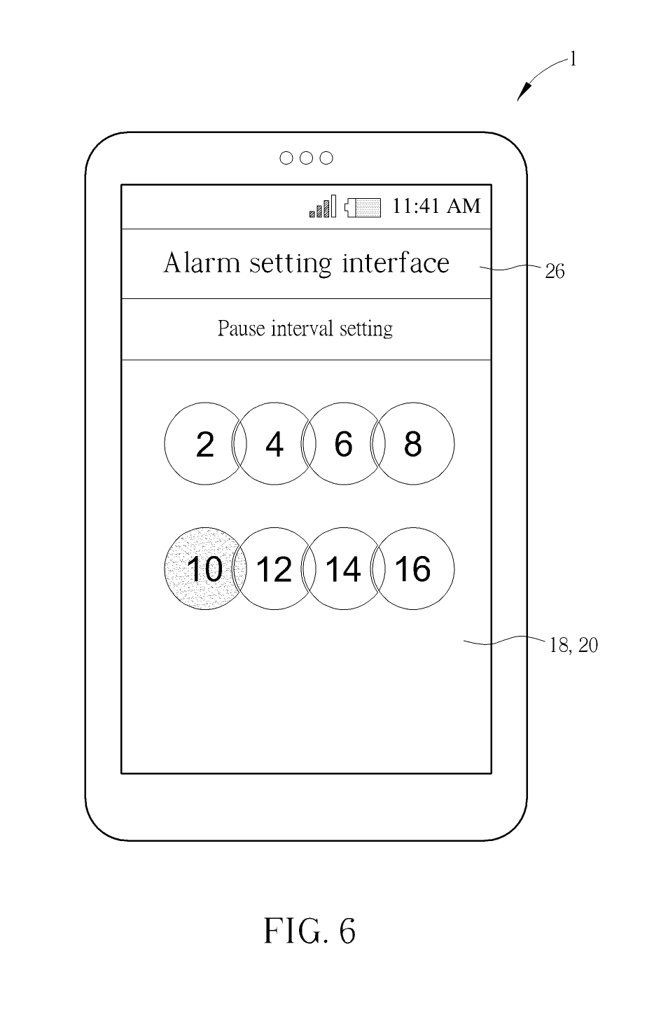

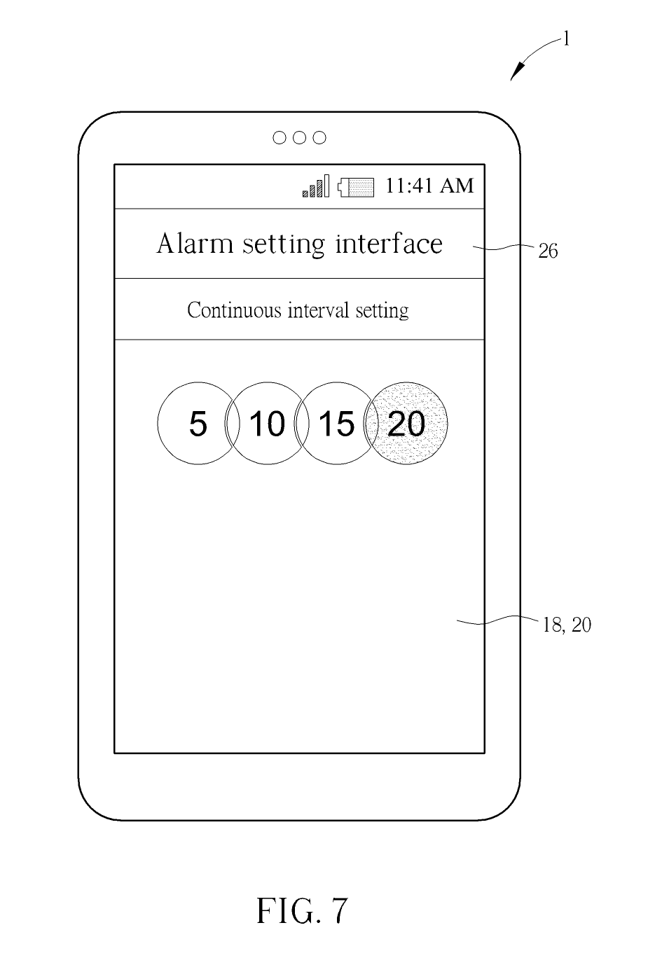

Referring to FIGS. 1 to 7, FIG. 1 is a functional block diagram illustrating a communication device 1 with missed call alarming function according to an embodiment of the invention, FIG. 2 is a schematic diagram illustrating a first screen displayed by the communication device 1 shown in FIG. 1, FIG. 3 is a schematic diagram illustrating a second screen displayed by the communication device 1 shown in FIG. 1, FIG. 4 is a schematic diagram illustrating a third screen displayed by the communication device 1 shown in FIG. 1, FIG. 5 is a schematic diagram illustrating a fourth screen displayed by the communication device 1 shown in FIG. 1, FIG. 6 is a schematic diagram illustrating a fifth screen displayed by the communication device 1 shown in FIG. 1, and FIG. 7 is a schematic diagram illustrating a sixth screen displayed by the communication device 1 shown in FIG. 1.

As shown in FIG. 1, the communication device 1 comprises a counter 10, a speaker 12, a processor 14, a storage unit 16, a display unit 18 and a touch unit 20, wherein the processor 14 is electrically connected to the counter 10, the speaker 12, the storage unit 16, the display unit 18 and the touch unit 20. In this embodiment, the communication device 1 may be any electronic devices with communication function, such as mobile phone, personal digital assistant (PDA), flat computer and so on; the storage unit 16 may be a memory, memory card or other data storage devices; the display unit 18 may be a liquid crystal display panel or other display devices; and the touch unit 20 may be a touch panel or other touch devices. In general, the touch unit 20 may be disposed on the display unit 18 so as to form a touch display module. Accordingly, the numerals 18 and 20 of the first screen to the sixth screen shown in FIGS. 2 to 7 are labeled at the same position. Furthermore, the communication device 1 may be further equipped with some necessary hardware or software components for specific purposes, such as a power supply, an operating system, a wireless communication module, an antenna, etc., and it depends on practical applications.

In this embodiment, the counter 10 is used for accumulating a number of missed calls and the storage unit 16 is used for storing a missed call list 22. In other words, when the communication device 1 has a missed call, the counter 10 will accumulate the number of missed calls and the processor 14 will record the number of missed calls in the missed call list 22 and display a process status of the missed call in the missed call list 22 (e.g. “having called back” or “not call back”), as shown in the first screen of FIG. 2. It should be noted that the process status of the missed call is changed by the processor 14 automatically. Before the user calls back the missed call, the processor 14 will set the process status of the missed call to be “not call back”. On the other hand, after the user calls back the missed call, the processor 14 will set the process status of the missed call to be “having called back”. Furthermore, the user can click “details” shown in the first screen of FIG. 2 to check an incoming call time of the missed call. Moreover, an alarm setting button 24 is further displayed in the first screen of FIG. 2. The user can click the alarm setting button 24 to set the missed call alarming function of the invention.

After the user clicks the alarm setting button 24, the first screen shown in FIG. 2 will be changed to the second screen shown in FIG. 3. The display unit 18 is used for displaying an alarm setting interface 26 shown in the second screen of FIG. 3. In this embodiment, the alarm setting interface 26 comprises five setting items including starting missed call alarming function, missed call threshold setting, alarm ring setting, pause interval setting, and continuous interval setting. If the missed call alarming function has been started by the user, the remaining four items can be operated accordingly. On the other hand, if the missed call alarming function has not been started by the user yet, the remaining four items cannot be operated accordingly.

After the user starts the missed call alarming function and clicks missed call threshold setting, the second screen shown in FIG. 3 will be changed to the third screen shown in FIG. 4. At this time, the user can operate the touch unit 20 to set the missed call threshold in the alarm setting interface 26. In this embodiment, the processor 14 is used for determining whether the number of missed calls is larger than the missed call threshold. The processor 14 will adjust a ring volume to maximum level and drive the speaker 12 to send an alarm ring out by the ring volume in maximum level when the number of missed calls is larger than the missed call threshold. For example, if the user sets the missed call threshold to be five, the processor 14 will adjust the ring volume to maximum level and drive the speaker 12 to send the alarm ring out by the ring volume in maximum level when the number of missed calls from the same contact received by the communication device 1 on one day is larger than five, so as to make the user notice that there is a missed call. Accordingly, the invention can prevent the user from missing urgent calls due to silent mode, vibration mode or small ring volume. It should be noted that after the user calls back the missed call, the processor 14 will stop to drive the speaker 12 to send the alarm ring out and set the number of missed calls to be zero.

Furthermore, after the user starts the missed call alarming function and clicks alarm ring setting, the second screen shown in FIG. 3 will be changed to the fourth screen shown in FIG. 5. At this time, the user can operate the touch unit 20 to set a sound file, a voice file or a music file to be the alarm ring in the alarm setting interface 26, wherein the voice file may comprise one prerecorded in the system and another one recorded by the user. In other words, the user can set exclusive alarm ring for different contacts.

Moreover, after the user starts the missed call alarming function and clicks pause interval setting, the second screen shown in FIG. 3 will be changed to the fifth screen shown in FIG. 6. At this time, the user can operate the touch unit 20 to set a pause interval in the alarm setting interface 26 such that the processor 14 will drive the speaker 12 to send the alarm ring out discontinuously according to the pause interval. For example, if the user sets the pause interval to be ten minutes and does not switch the alarm ring off, the processor 14 will drive the speaker 12 to send the alarm ring out every ten minutes.

Still further, after the user starts the missed call alarming function and clicks continuous interval setting, the second screen shown in FIG. 3 will be changed to the sixth screen shown in FIG. 7. At this time, the user can operate the touch unit 20 to set a continuous interval in the alarm setting interface 26 such that the processor 14 will drive the speaker 12 to send the alarm ring out continuously within the continuous interval. For example, if the user sets the continuous interval to be twenty minutes and does not switch the alarm ring off, the processor 14 will drives the speaker 12 to send the alarm ring out continuously within twenty minutes and then switch the alarm ring off.

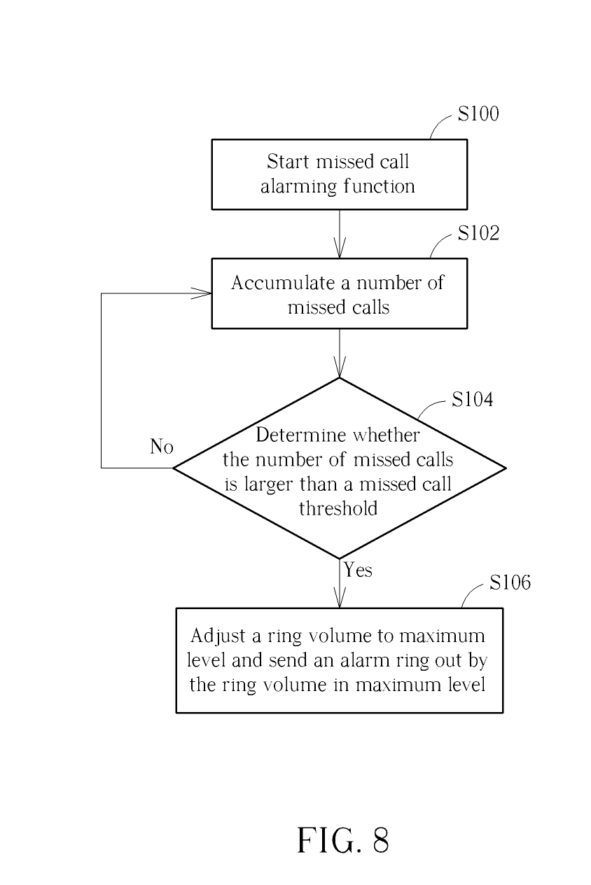

Referring to FIG. 8, FIG. 8 is a flowchart illustrating a missed call alarming method according to an embodiment of the invention. First of all, step S100 is performed to start missed call alarming function. Afterward, step S102 is performed to accumulate a number of missed calls. Step S104 is then performed to determine whether the number of missed calls is larger than a missed call threshold. When the number of missed calls is larger than the missed call threshold, step S106 is performed to adjust a ring volume to maximum level and send an alarm ring out by the ring volume in maximum level. When the number of missed calls is not larger than the missed call threshold, step S102 is performed again to accumulate the number of missed calls continuously. It should be noted that the detailed operation and principle have been mentioned in the above and will not be depicted herein again.

Furthermore, the first to sixth screens shown in FIGS. 2 to 7 and the control logics of the missed call alarming method shown in FIG. 8 can be implemented by software. It is reasonably expected that each part or function of the control logics may be implemented by software, hardware or the combination thereof. Moreover, the control logics can be embodied by a computer readable storage medium, wherein the computer readable storage medium stores instructions, which can be executed by the communication device 1 so as to generate control command for controlling the communication device 1 to execute corresponding function.

As mentioned in the above, when the communication device has a missed call, the counter will accumulate the number of missed calls and the processor will determine whether the number of missed calls is larger than the missed call threshold (e.g. three, five, etc.). When the number of missed calls is larger than the missed call threshold, the processor will adjust the ring volume to maximum level and drive the speaker to send the alarm ring out by the ring volume in maximum level so as to make the user notice that there is a missed call. Accordingly, the invention can prevent the user from missing urgent calls due to silent mode, vibration mode or small ring volume. Furthermore, the user can set exclusive alarm ring for different contacts and set pause interval and continuous interval of sending the alarm ring out.

Those skilled in the art will readily observe that numerous modifications and alterations of the device and method may be made while retaining the teachings of the invention. Accordingly, the above disclosure should be construed as limited only by the metes and bounds of the appended claims.

1. A missed call alarming method comprising:
accumulating a number of missed calls;
determining whether the number of missed calls is larger than a missed call threshold; and
adjusting a ring volume to maximum level and sending an alarm ring out by the ring volume when the number of missed calls is larger than the missed call threshold.

2. The missed call alarming method of claim 1, further comprising:
recording the number of missed calls in a missed call list; and
displaying a process status of the missed call in the missed call list.

3. The missed call alarming method of claim 1, further comprising:
setting the missed call threshold in an alarm setting interface.

4. The missed call alarming method of claim 3, further comprising:
setting a sound file, a voice file or a music file to be the alarm ring in the alarm setting interface.

5. The missed call alarming method of claim 3, further comprising:
setting a pause interval in the alarm setting interface; and
sending the alarm ring out discontinuously according to the pause interval.

6. The missed call alarming method of claim 3, further comprising:
setting a continuous interval in the alarm setting interface; and
sending the alarm ring out continuously within the continuous interval.

7. A communication device with missed call alarming function comprising:
a counter for accumulating a number of missed calls;
a speaker; and
a processor, electrically connected to the counter and the speaker, for determining whether the number of missed calls is larger than a missed call threshold, the processor adjusting a ring volume to maximum level and driving the speaker to send an alarm ring out by the ring volume when the number of missed calls is larger than the missed call threshold.

8. The communication device with missed call alarming function of claim 7, further comprising a storage unit, electrically connected to the processor, for storing a missed call list, wherein the processor records the number of missed calls in the missed call list and displays a process status of the missed call in the missed call list.

9. The communication device with missed call alarming function of claim 7, further comprising:
a display unit, electrically connected to the processor, for displaying an alarm setting interface; and
a touch unit, electrically connected to the processor, for setting the missed call threshold in the alarm setting interface.

10. The communication device with missed call alarming function of claim 9, wherein the touch unit is used for setting a sound file, a voice file or a music file to be the alarm ring in the alarm setting interface.

11. The communication device with missed call alarming function of claim 9, wherein the touch unit is used for setting a pause interval in the alarm setting interface and the processor drives the speaker to send the alarm ring out discontinuously according to the pause interval.

12. The communication device with missed call alarming function of claim 9, wherein the touch unit is used for setting a continuous interval in the alarm setting interface and the processor drives the speaker to send the alarm ring out continuously within the continuous interval.
